(19) United States
(12) Patent Application Publication
(10) Pub. No.: US 2026/0245990 A1
(43) Pub. Date: Aug. 20, 2026

(54) FIRE EXTINGUISHING DEVICE FOR ENERGY STORAGE SYSTEM AND FIRE EXTINGUISHING DEVICE FOR BATTERY MODULE

(71) Applicant: Samsung SDI Co., Ltd., Yongin-si (KR)

(72) Inventor: Deok Jo Kang, Suwon-si (KR)

(73) Assignee: Samsung SDI Co., Ltd., Yongin-si (KR)

(21) Appl. No.: 19/409,045

(22) Filed: Dec. 4, 2025

(30) Foreign Application Priority Data
Feb. 18, 2025 (KR) 10-2025-0020886

(51) Int. Cl. H01M 10/42; A62C 3/16; A62C 37/40; H01M 10/48; H01M 50/209; H01M 50/682

(52) U.S. Cl. CPC H01M 10/425; A62C 3/16; A62C 37/40; H01M 10/482; H01M 10/486; H01M 50/209; H01M 50/682

(57) ABSTRACT

Provided are a fire extinguishing device for an energy storage system and a fire extinguishing device for a battery module to extinguish a fire in a cable connected to a control unit to transmit and receive electrical signals. To this end, the fire extinguishing device includes a battery module including a plurality of battery cells, a battery rack supporting the battery module, a module fire extinguishing unit configured to sense a fire of the battery module and spray a fire extinguishing agent on the battery module, a control unit connected to the battery module through a cable and configured to sense a state of the battery module, and a cable fire extinguishing unit configured to fix the cable and including the fire extinguishing agent.

### CROSS REFERENCE TO RELATED APPLICATIONS

This present application claims priority to and the benefit under 35 U.S.C. §119(a)-(d) of Korean Patent Application No. 10-2025-0020886, filed on Feb. 18, 2025, in the Korean Intellectual Property Office, the entire disclosure of which is incorporated herein by reference.

### FIELD

The present disclosure relates to a fire extinguishing device for an energy storage system and a fire extinguishing device for a battery module.

### BACKGROUND

Generally, an energy storage system (ESS) (or an energy storage device) refers to a system that stores surplus electricity or stores produced electricity using renewable energy. By using the ESS, idle power is stored in a time zone of a low electricity demand and electricity is supplied in a time zone of a high electricity demand, thereby smoothly controlling power supply.

In a space or facility where the ESS is installed and applied, it is mandatory to install equipment to prevent a battery fire from occurring due to electric shock, short-circuit, external surge, etc. A general extinguishing system includes a fire detection sensor, a sprinkler or fire extinguishing agent sprayer installed around a battery rack, on a ceiling, etc., and so forth.

As an energy density of a battery continuously increases, the amount of flame and a pressure of ejection are increasing at a vent of a battery cell, making it difficult to early extinguish or suppress a fire merely with general fire suppression equipment. Accordingly, there is an increasing demand for an ESS fire extinguishing system capable of effectively suppressing multiple battery fires and early extinguishing high-pressure fires.

The herein-described information disclosed in the technology that forms the background of the present disclosure is only intended to improve understanding of the background of the present disclosure, and thus may include information that does not constitute the related art.

### SUMMARY

The present disclosure is proposed to solve these problems and aims to a fire extinguishing device for an energy storage system and a fire extinguishing device for a battery module in which a cable for transmitting information of a battery cell is confined and in the event of a fire due to a short-circuit of the cable, the fire is extinguished quickly.

These and other aspects and features of the present disclosure will be described in or will be apparent from the following description of some embodiments of the present disclosure.

According to aspects of the present disclosure, a fire extinguishing device for an energy storage system includes a battery module including a plurality of battery cells, a battery rack supporting the battery module, a module fire extinguishing unit configured to sense a fire of the battery module and spray a fire extinguishing agent on the battery module, a control unit connected to the battery module through a cable and configured to sense a state of the battery module, and a cable fire extinguishing unit configured to fix the cable and including the fire extinguishing agent.

The module fire extinguishing unit may include a module sensing unit configured to sense at least any one of a temperature change and a size change of the battery module and a module spraying unit configured to spray a fire extinguishing agent on the battery module according to a sensing signal of the module sensing unit.

The module sensing unit may include at least one of a temperature sensor configured to sense a temperature of the battery module and a size sensor configured to sense a size of the battery module.

The temperature sensor may be further configured to measure a temperature of each battery cell in the battery module.

The size sensor may be mounted on the battery rack and may be further configured to photograph the size of the battery module.

The fire extinguishing device may further include a housing including the battery rack, in which the size sensor is mounted on the housing and is further configured to photograph a size of the battery rack.

The module spraying unit may include a fire extinguishing tank configured to store the fire extinguishing agent, a fire extinguishing pipe connected to the fire extinguishing tank and configured to guide the fire extinguishing agent, and a fire extinguishing nozzle formed on the fire extinguishing pipe and configured to spray the fire extinguishing agent on the battery module.

The cable fire extinguishing unit may include a fire extinguishing sheet including the fire extinguishing agent and a fire extinguishing tape formed on the fire extinguishing sheet and attached to the cable to fix the cable.

The fire extinguishing sheet may include a sheet body to which the fire extinguishing tape is coupled and a sheet capsule provided in plural in the sheet body and including the fire extinguishing agent.

The sheet body may be mixed with epoxy and an additive and molded.

The additive may be a hardener hardening the epoxy such that the sheet capsule is uniformly distributed.

A content rate of the sheet capsule may be 30% to 50%.

A thickness of the fire extinguishing sheet may be greater than a thickness of the fire extinguishing tape by five times to fifteen times.

A width of the cable fire extinguishing unit may be 5 mm to 30 mm.

The cable fire extinguishing unit may surround the cable provided in plural, and an installation interval of the cable fire extinguishing unit may be 100 mm to 200 mm.

According to aspects of the present disclosure, a fire extinguishing device for a battery module includes a battery module including a plurality of battery cells, a control unit connected to the battery module through a cable and configured to sense a state of the battery module, and a cable fire extinguishing unit configured to fix the cable and including the fire extinguishing agent.

The cable fire extinguishing unit may include a fire extinguishing sheet including the fire extinguishing agent and a fire extinguishing tape formed on the fire extinguishing sheet and attached to the cable to fix the cable.

The fire extinguishing sheet may include a sheet body to which the fire extinguishing tape is coupled and a sheet capsule provided in plural in the sheet body and including the fire extinguishing agent.

The sheet body may be mixed with epoxy and an additive and molded.

A content rate of the sheet capsule may be 30% to 50%.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 schematically shows a fire extinguishing device for an energy storage system, according to embodiments of the present disclosure;

FIG. 2 schematically shows a battery rack according to embodiments of the present disclosure;

FIG. 3 schematically shows a state of a module sensing unit according to embodiments of the present disclosure sensing a temperature;

FIG. 4 schematically shows a state of a module sensing unit according to embodiments of the present disclosure sensing a size and a position;

FIG. 5 schematically shows a module spraying unit according to embodiments of the present disclosure;

FIG. 6 is a plan view schematically showing a cable fire extinguishing unit according to embodiments of the present disclosure;

FIG. 7 is a side view schematically showing a cable fire extinguishing unit according to embodiments of the present disclosure;

FIG. 8 shows in detail a sheet body of FIG. 7;

FIG. 9 schematically shows a cable fire extinguishing unit according to embodiments of the present disclosure;

FIG. 10 schematically shows a state of a cable fire extinguishing unit according to embodiments of the present disclosure confining a cable;

FIG. 11 schematically shows a fire extinguishing device for a battery module, according to embodiments of the present disclosure;

FIG. 12 is a plan view schematically showing a cable fire extinguishing unit according to embodiments of the present disclosure;

FIG. 13 is a side view schematically showing a cable fire extinguishing unit according to embodiments of the present disclosure;

FIG. 14 shows in detail a sheet body of FIG. 13; and

FIG. 15 schematically shows an arrangement state of a cable fire extinguishing unit according to embodiments of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

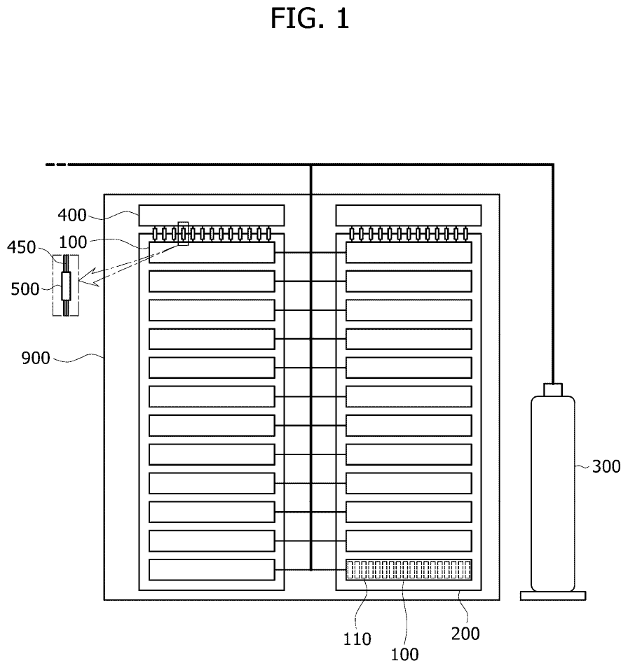

FIG. 1 schematically shows a fire extinguishing device for an energy storage system, according to embodiments of the present disclosure. Referring to FIG. 1, a fire extinguishing device for an energy storage system (ESS) according to embodiments of the present disclosure may include a battery module 100, a battery rack 200, a module fire extinguishing unit 300, a control unit 400, and a cable fire extinguishing unit 500.

The battery module 100 may include a plurality of battery cells 110. The battery module 100 may accommodate the plurality of battery cells 110 in a case having an approximately hexahedral shape. The battery cells 110 may be arranged to have a specific space therebetween. The plurality of battery cells 110 may be arranged in a line to correspond to a size of the battery module 100. The battery cell 110 may be configured as a secondary battery that is chargeable and dischargeable.

The battery rack 200 may support the battery module 100. The battery pack 200 may be made of a metal material, and a sheet of a flame-resistance material may be attached to the battery pack 200 depending on a need. The battery rack 200 may have an approximately cuboidal shape.

The module fire extinguishing unit 300 may sense a fire of the battery module 100 and spray a fire extinguishing agent on the battery module 100. The fire extinguishing agent may include one or more of argon (Ar), nitrogen (N), and carbon dioxide (CO2). If CO2 is used as a fire extinguishing agent, CO2 may be liquefied and stored in a low-temperature and high-pressure state.

The control unit 400 may be connected to the battery module 100 through a cable 450 to sense a state of the battery module 100. The control unit 400 may manage each battery module 100 and manage each battery cell 110 included in the battery module 100. The control unit 400 may be connected to each battery module 100. The cable 450 may be connected to each battery cell 110.

The control unit 400 may include a low-level control unit and a high-level control unit. The low-level control unit may be individually connected to each battery module 100, and the high-level control unit may be connected to each low-level control unit. Each battery module 100 may be connected to the high-level control unit. The control unit 400 may include a detection device, a balancing device, and a control device.

The detection device may sense a state (a voltage, a current, a temperature, etc.) of the battery cell 110 to detect state information indicating the state of the battery cell 110. The detection device may detect a voltage of each battery cell 110 constituting the battery module 100. The detection device may detect a current of each battery cell 110 constituting the battery module 100. The detection device may detect a temperature of the battery cell 110 or an ambient temperature in at least one point of the battery module 100.

The balancing device may perform balancing of the battery cells 110 constituting the battery module 100.

The control device may receive state information (a voltage, a current, a temperature, etc.) of the battery cell 110 from the detection device. The control device may monitor and calculate a state (a voltage, a current, a temperature, a state of charge (SOC), a lifetime, a state of health (SOH), etc.) of the battery cell 110, based on the state information received from the detection device. The control device may perform a control function (e.g., temperature control, balancing control, charging/discharging control, etc.), a protection function (e.g., prevention of over-discharge, over-charge, and over-current, short-circuit, fire extinguishment, etc.), and so forth, based on a state monitoring result. The control device may also perform a wired or wireless communication function with an external device (e.g., a higher-level controller, a vehicle, a charger, a PCS, etc.) of the battery module 100. The control device may control a charging/discharging operation and a protection operation of the battery.

The detection device, the balancing device, and the control device may each include a processor and a memory.

The processor may be implemented as a central processing unit (CPU) or a system on chip (SoC), and may control a plurality of hardware or software components connected thereto by running an operating system or an application, and may perform various data processing and operations. The processor may be configured to execute at least one instruction stored in the memory and to store data resulting from the execution of the instruction in the memory.

The memory may store at least one instruction to be executed by the processor. The memory may be implemented as a volatile storage medium and/or a non-volatile storage medium, and may be implemented as, for example, read-only memory (ROM) and/or random access memory (RAM).

The cable fire extinguishing unit 500 may fix the cable 450 and include a fire extinguishing agent. The cable fire extinguishing unit 500 may maintain a fixed state by winding a cable bundle including a plurality of cables 450 bundled together. The cable fire extinguishing unit 500 may be directly attached to a separate fixture to fix the cable 450. A separate fixing wire may be fixed to the fixture, and the fixing wire and the cable 450 may be fixed by the cable fire extinguishing unit 500. An adhesive may be attached to the exterior of the cable fire extinguishing unit 500, and a fire extinguishing agent may be included in the interior of the cable fire extinguishing unit 500. As the cable fire extinguishing unit 500 melts due to heat, the fire extinguishing agent may be exposed and thus a fire extinguishing operation may be performed. As the cable fire extinguishing unit 500 melts due to external heat, the cable fire extinguishing unit 500 may provide the fire extinguishing agent and thus prevent an event of the cable 450 from further occurring. The cable extinguishing unit 500 may quickly extinguish a fire in the cable 450.

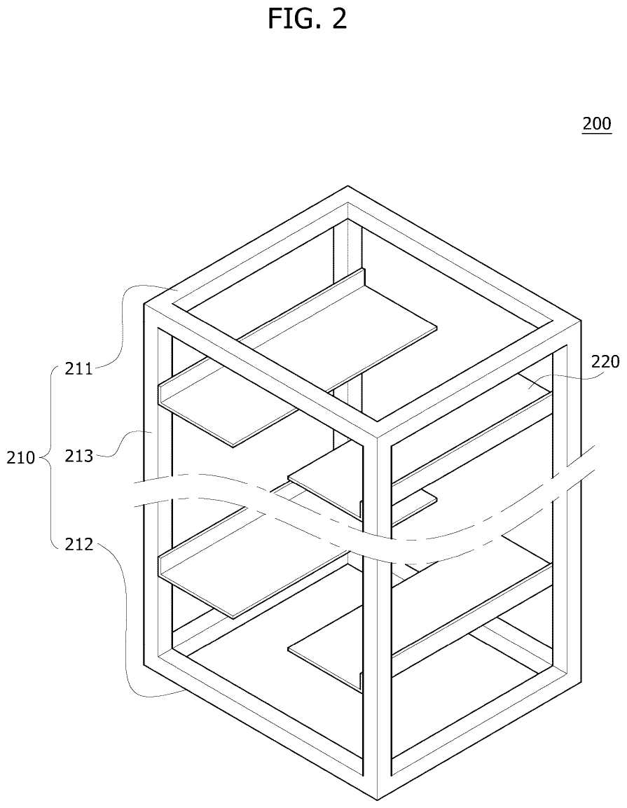

FIG. 2 schematically shows a battery rack according to embodiments of the present disclosure. Referring to FIG. 2, the battery rack 200 according to embodiments of the present disclosure may include a rack frame 210 and a rack support 220.

On the rack frame 210, the module fire extinguishing unit 300 and the control unit 400 may be arranged selectively. The rack frame 210 may form a frame having a cuboidal shape. The rack frame 210 may include an upper frame 211, a lower frame 212 arranged under the upper frame 211, and a connection frame 213 connecting the upper frame 211 to the lower frame 212.

The rack support 220 may be formed on the rack frame 210 and support the battery module 100. A plurality of rack supports 220 may be spaced apart from each other in a longitudinal direction of the connection frame 213, and a pair thereof may be arranged to face each other at the same height to support the plurality of battery modules 100 vertically.

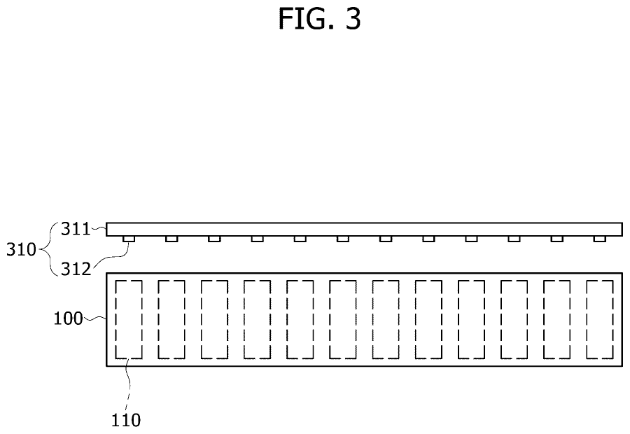

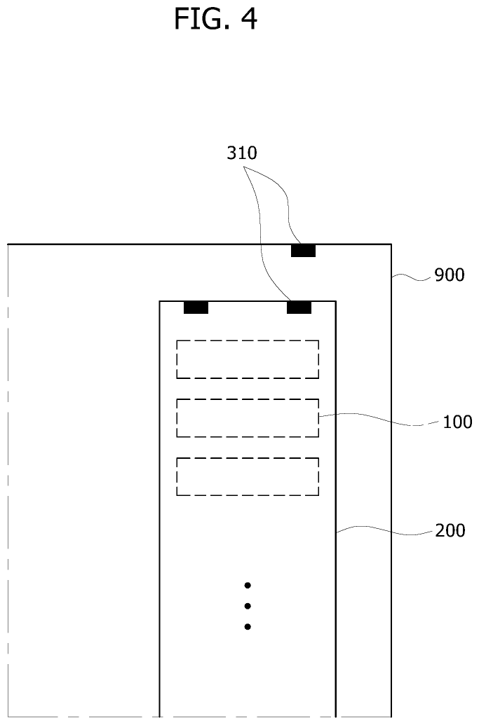

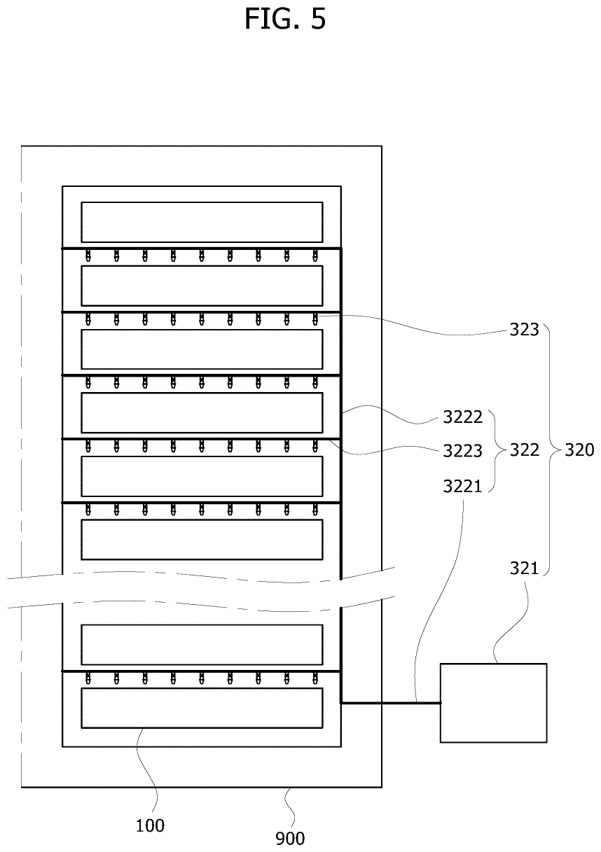

FIG. 3 schematically shows a state of a module sensing unit according to embodiments of the present disclosure sensing a temperature. FIG. 4 schematically shows a state of a module sensing unit according to embodiments of the present disclosure sensing a size and a position. FIG. 5 schematically shows a module spraying unit according to embodiments of the present disclosure. Referring to FIGS. 3 to 5, the module fire extinguishing unit 300 according to embodiments of the present disclosure may include a module sensing unit 310 and a module spraying unit 320.

The module sensing unit 310 may sense at least any one of a temperature change and a size change of the battery module 100. The module sensing unit 310 may be mounted on the battery rack 200 or on a housing 900 having the battery rack 200 built therein.

The module spraying unit 320 may spray a fire extinguishing agent on the battery module 100 according to a sensing signal of the module sensing unit 310. The module spraying unit 320 may be entirely built in the housing 900 or a part thereof may be arranged on the exterior of the housing 900. The fire extinguishing agent may include one or more of argon (Ar), nitrogen (N), and carbon dioxide (CO2). If CO2 is used as a fire extinguishing agent, CO2 may be liquefied and stored in a low-temperature and high-pressure state.

The module sensing unit 310 according to embodiments of the present disclosure may include at least any one of the temperature sensor 311 and the size sensor 312.

The temperature sensor 311 may sense the temperature of the battery module 100. The temperature sensor 311 may measure the temperature of each battery module 100. The temperature sensor 311 may be mounted on the battery rack 200 and photograph the battery module 100 to sense the temperature. The temperature sensor 311 may also measure a temperature of each of the plurality of battery cells 110.

The size sensor 312 may sense a size or a position of the battery module 100. The size sensor 312 may be mounted on the battery rack 200 and photograph the size of the battery module 100 to sense expansion of the battery module 100. As the size of the battery module 100 expands over the battery cell 110, the size sensor 312 may sense the expansion. The size sensor 312 may sense a position of an outer side of the battery module 100.

If the size of the battery module 100 reaches a set size or the battery module 100 reaches a set position, the module spraying unit 320 may receive a sensing signal of the size sensor 312 and spray the fire extinguishing agent.

The size sensor 312 may be mounted on the housing 900 including the battery rack 200 and photograph the size of the battery rack 200 to sense expansion of the battery rack 200. That is, if the battery module 100 closely contacts the battery rack 200 according to a design environment, the battery rack 200 may be deformed and expand by being pushed by the battery module 100 when the battery module 100 intermittently expands. The size sensor 312 mounted on the housing 900 may sense deformation of the battery rack 200. The size sensor 312 mounted on the housing 900 may also sense the position of the outer side of the battery rack 200.

If the size of the battery rack 200 reaches a set size or the battery module 100 reaches a set position, the module spraying unit 320 may receive a sensing signal of the size sensor 312 and spray the fire extinguishing agent.

The module spraying unit 320 according to embodiments of the present disclosure may include a fire extinguishing tank 321, a fire extinguishing pipe 322, and a fire extinguishing nozzle 323.

The fire extinguishing agent may be stored in the fire extinguishing tank 321. The fire extinguishing tank 321 may be stored inside or outside the housing 900.

The fire extinguishing pipe 322 may be connected to the fire extinguishing tank 321 to guide the fire extinguishing agent. The fire extinguishing pipe 322 may be mounted on the battery rack 200 and may be arranged above the battery module 100. The fire extinguishing pipe 322 may include a first pipe 3221, a second pipe 3222, and a third pipe 3223. The first pipe 3221 may be connected to the fire extinguishing tank 321. The second pipe 3222 may extend from the first pipe 3221 and may be fixedly installed on the housing 900 or the battery rack 200. The third pipe 3223 may be connected to the second pipe 3222 and may extend toward the plurality of battery modules 100 arranged vertically inside the battery rack 200. A plurality of third pipes 3223 may be branched in the longitudinal direction of the second pipe 3222 and may be arranged above or under the battery module 100.

The fire extinguishing nozzle 323 may be formed in the fire extinguishing pipe 322, and may spray the fire extinguishing agent on the battery module 100. A plurality of fire extinguishing nozzles 323 may be arranged in the longitudinal direction of the third pipe 3223 to respond to a fire of the battery module 100 occurring in various positions.

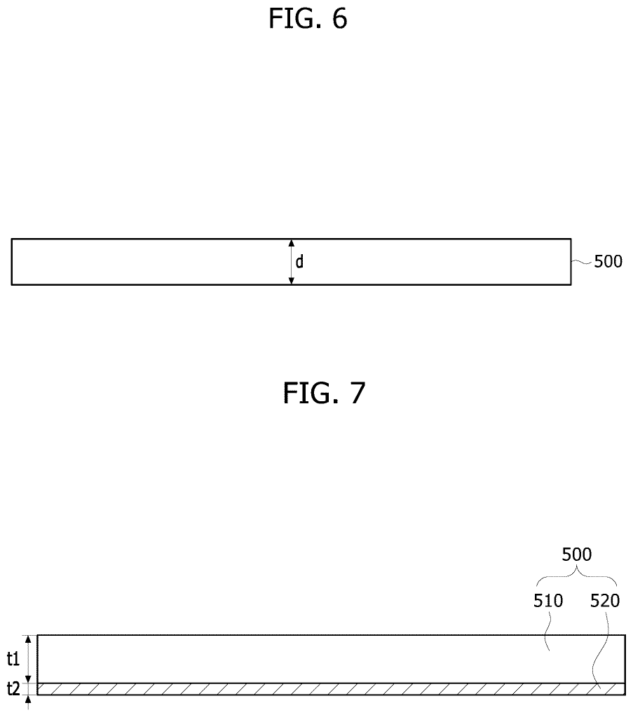

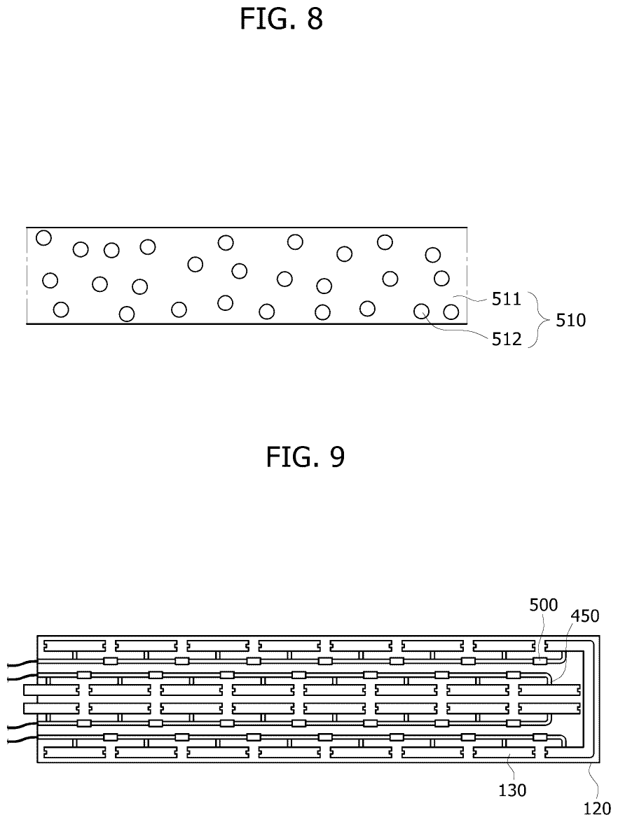

FIG. 6 is a plan view schematically showing a cable fire extinguishing unit according to embodiments of the present disclosure, FIG. 7 is a side view schematically showing a cable fire extinguishing unit according to embodiments of the present disclosure, and FIG. 8 shows in detail a sheet body of FIG. 7. FIG. 9 schematically shows a cable fire extinguishing unit according to embodiments of the present disclosure, and

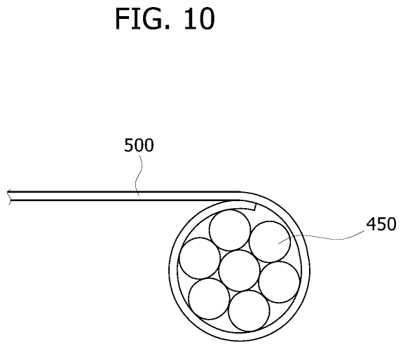

FIG. 10 schematically shows a state of a cable fire extinguishing unit according to embodiments of the present disclosure confining a cable. Referring to FIGS. 6 to 10, the cable fire extinguishing unit 500 according to embodiments of the present disclosure may include a fire extinguishing sheet 510 and a fire extinguishing tape 520.

The fire extinguishing agent may be built in the fire extinguishing sheet 510, and the fire extinguishing tape 520 formed in the fire extinguishing sheet 510 may be attached to the cable 450 to fix the cable 450. An adhesive may be applied to opposite sides of the fire extinguishing tape 520, and a side surface of the fire extinguishing tape 520 may be attached to the fire extinguishing sheet 510. The other side surface of the fire extinguishing tape 520 may be attached to the cable 450 and the fixture. The fire extinguishing tape 520 may wind the plurality of cables 450 bundled together to prevent the cables 450 from being separated and may be attached to the fixture to fix the cable 450.

The fire extinguishing sheet 510 may include a sheet body 511 and a sheet capsule 512.

The fire extinguishing tape 520 may be coupled to the sheet body 511. A plurality of sheet capsules 512 may be built in the sheet body 511. The sheet capsule 512 may be a spherical capsule, and may store the fire extinguishing agent inside the capsule.

The sheet body 511 may be molded by mixing epoxy and an additive. As the additive, a hardener for hardening epoxy to induce uniform arrangement of the sheet capsule 512 may be used.

A mixed liquid may be produced by mixing epoxy, the additive, and the sheet capsule 512, and then the mixed liquid may be put into a molding frame and may be left. After a certain amount of time, epoxy may be hardened and the sheet capsule 512 may be uniformly distributed in the epoxy.

A content rate of the sheet capsule 512 may be about 30% to 50%. That is, a volume of the sheet capsule 512 included in the sheet body 511 with respect to a total volume of the sheet body 511 may be 30% to 50%. A capacity of the sheet capsule 512 with respect to a capacity of epoxy and the additive may be 30% to 50%.

A thickness t1 of the fire extinguishing sheet 510 may be designed to be greater by five times to 15 times than a thickness t2 of the fire extinguishing tape 520. That is, if the thickness t2 of the fire extinguishing tape 520 is 1 mm, the thickness t1 of the fire extinguishing sheet 510 may be 5 mm to 15 mm.

A width d of the cable fire extinguishing unit 500 may be 5 mm to 30 mm. If the width d of the cable fire extinguishing unit 500 is less than 5 mm, it is difficult for the sheet capsule 512 to enter the cable fire extinguishing unit 500, and if the width d of the cable fire extinguishing unit 500 is greater than 30 mm, the cable 450 may be lifted.

The cable fire extinguishing unit 500 may surround the plurality of cables 450. An installation interval of the cable fire extinguishing unit 500 may be 100 mm to 200 mm.

A bus bar 130 may be included in a bus bar holder 120 which covers an open top surface in one battery module 100 or integrally manages the plurality of battery modules 100. The bus bar 130 may be connected to a terminal provided in each battery cell 110 or to a positive bus bar or a negative bus bar provided in each battery module 100. The cable 450 may be electrically connected to each bus bar 130 and transmit an electrical signal. The cable fire extinguishing unit 500 may surround the plurality of cables 450 such that the plurality of cables 450 connected to each bus bar 130 may be arranged in a bundle. A part of the cable fire extinguishing unit 500 may surround the cable 450 and the other part may be attached to the bus bar holder 120 to confine the cable 450.

A description will be made herein of a fire extinguishing operation of the fire extinguishing device for an energy storage system according to embodiments of the present disclosure structured as described herein.

The module sensing unit 310 may sense a state of the battery module 100 or the battery cell built in the battery module 100. The module sensing unit 310 may sense a size change or a temperature change of the battery module 100 or the battery cell 110.

The module spraying unit 320 may spray the fire extinguishing agent based on data sensed by the module sensing unit 310 to prevent explosion or a fire of the battery module 100.

The control unit 400 and each battery cell 110 may be electrically connected to each other by the cable 450 to transmit and receive signals. Each cable 450 may be separately connected to each battery cell 110, and the cable fire extinguishing unit 500 may surround and fix the plurality of cables 450 in a bundle.

The cable fire extinguishing unit 500 may include an adhesive so as to be attached to the cable 450 and the fixture, and the cable fire extinguishing unit 500 may store a capsule including the fire extinguishing agent. If the cable 450 is heated by a short-circuit or the cable 450 is heated by a fire of the battery module 100 or the battery cell 110, the cable fire extinguishing unit 500 may melt to block a fire of the cable 450.

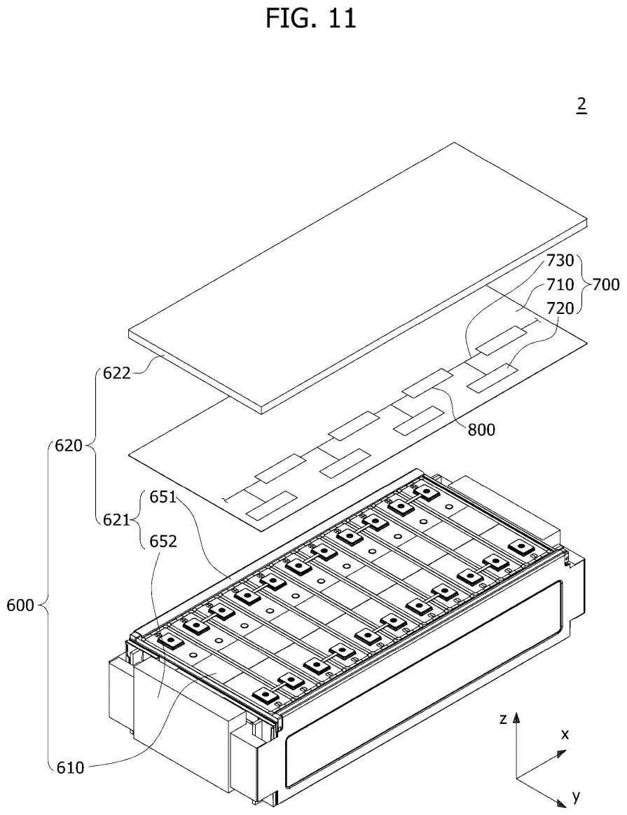

FIG. 11 schematically shows a fire extinguishing device for a battery module, according to embodiments of the present disclosure. Referring to FIG. 11, a fire extinguishing device 2 for a battery module according to embodiments of the present disclosure may include a battery module 600, a control unit 700, and a cable fire extinguishing unit 800.

The battery module 600 may include a plurality of battery cells 610. The battery module 600 may include the battery cells 610 and a housing 620.

The battery cell 610 may function as a unit structure for storing and supplying power in the battery module 600. The battery cell 610 may have an exterior in an approximately angular hexahedral shape.

The housing 620 may provide a space for receiving the battery cells 610 in a line. The housing 620 may include a housing body 621 having an open top and a housing cover 622 covering the housing body 621. The housing body 621 may include a first body partition wall 651 covering the battery cells 610 arranged in a line in an x-axis direction and a second body partition wall 652 connecting a pair of first body partition walls 651 and arranged to face the battery cells 610.

The control unit 700 may be connected to the battery module 600 through a cable 730 to sense a state of the battery module 600. The control unit 700 may manage each battery cell 610.

The control unit 700 may include a low-level control unit and a high-level control unit. The low-level control unit may be individually connected to each battery cell 610, and the high-level control unit may be connected to each low-level control unit. Each battery cell 610 may be connected to the high-level control unit. The control unit 700 may include a detection device, a balancing device, and a control device.

The detection device may sense a state (a voltage, a current, a temperature, etc.) of the battery cell 610 to detect state information indicating the state of the battery cell 610. The detection device may detect a voltage of each battery cell 610 constituting the battery module 600. The detection device may detect a current of each battery cell 610 constituting the battery module 600. The detection device may detect a temperature of the battery cell 610 or an ambient temperature in at least one point of the battery module 600.

The balancing device may perform balancing of the battery cells 610 constituting the battery module 600.

The control device may receive state information (a voltage, a current, a temperature, etc.) of the battery cell 610 from the detection device. The control device may monitor and calculate a state (a voltage, a current, a temperature, a state of charge (SOC), a lifetime, a state of health (SOH), etc.) of the battery cell 610, based on the state information received from the detection device. The control device may perform a control function (e.g., temperature control, balancing control, charging/discharging control, etc.), a protection function (e.g., prevention of over-discharge, over-charge, and over-current, short-circuit, fire extinguishment, etc.), and so forth, based on a state monitoring result. The control device may also perform a wired or wireless communication function with an external device (e.g., a higher-level controller, a vehicle, a charger, a PCS, etc.) of the battery module 600. The control device may control a charging/discharging operation and a protection operation of the battery.

The detection device, the balancing device, and the control device may each include a processor and a memory.

The processor may be implemented as a CPU or an SoC, and may control a plurality of hardware or software components connected thereto by running an operating system or an application, and may perform various data processing and operations. The processor may be configured to execute at least one instruction stored in the memory and to store data resulting from the execution of the instruction in the memory.

The memory may store at least one instruction to be executed by the processor. The memory may be implemented as a volatile storage medium and/or a non-volatile storage medium, and may be implemented as, for example, ROM and/or RAM.

The control unit 700 may include an insulating plate 710, a bus bar 720, and a cable 730.

The insulating plate 710 may be made of an insulating material. The insulating plate 710 may be arranged between the battery cell 610 and a housing cover 622. The insulating plate 710 may be mounted on a housing body 621 or placed on the battery cell 610 The bus bar 720 may be mounted on the insulating plate 710 so as to be exposed to outside, and may be connected to a terminal of the battery cell 610. Each bus bar 720 may be connected to a terminal formed in each battery cell 610.

The cable 730 may be connected to each bus bar 720 at an end thereof and to a control board (not shown) arranged outside the battery module 600 at the other end thereof.

A cable fire extinguishing unit 800 may fix the cable 730 and include a fire extinguishing agent. The cable fire extinguishing unit 800 may maintain a fixed state by winding a cable bundle including the plurality of cables 730 bundled together. The cable fire extinguishing unit 800 may be directly attached to a separate fixture to fix the cable 730. A separate fixing wire may be fixed to the fixture, and the fixing wire and the cable 730 may be fixed by the cable fire extinguishing unit 800. An adhesive may be attached to the exterior of the cable fire extinguishing unit 800, and a fire extinguishing agent may be included in the interior of the cable fire extinguishing unit 800. As the cable fire extinguishing unit 800 melts due to heat, the fire extinguishing agent may be exposed and thus a fire extinguishing operation may be performed. The cable fire extinguishing unit 800 provides the fire extinguishing agent due to external heat and thus prevent an event of the cable 730 from further occurring. The cable extinguishing unit 800 may quickly extinguish a fire in the cable 730.

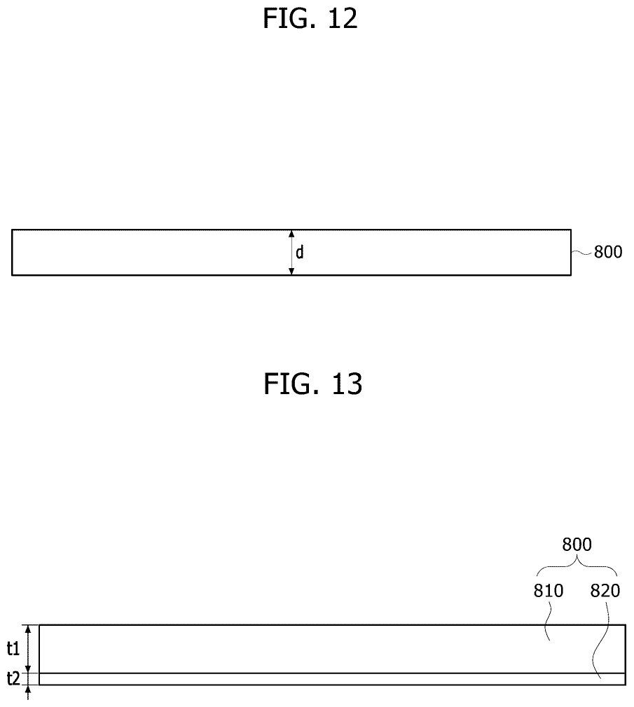

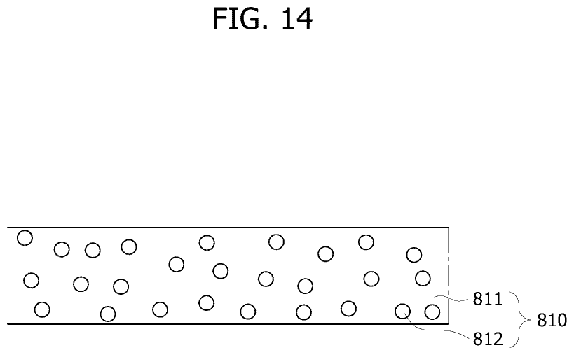

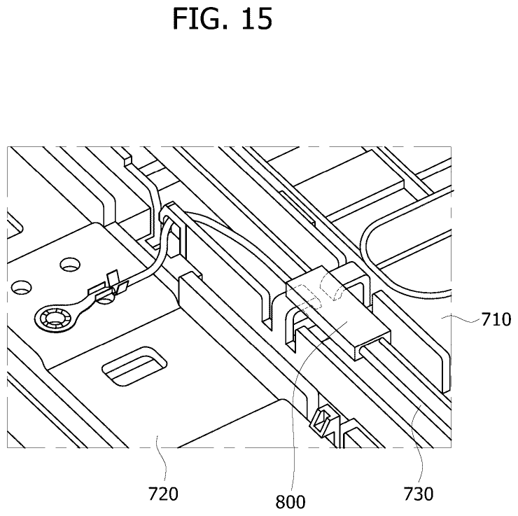

FIG. 12 is a plan view schematically showing a cable fire extinguishing unit according to embodiments of the present disclosure, and FIG. 13 is a side view schematically showing a cable fire extinguishing unit according to embodiments of the present disclosure. FIG. 14 shows in detail a sheet body of FIG. 13, and FIG. 15 schematically shows an arrangement state of a cable fire extinguishing unit according to embodiments of the present disclosure. Referring to FIGS. 11 to 15, a cable fire extinguishing unit 800 according to embodiments of the present disclosure may include a fire extinguishing sheet 810 and a fire extinguishing tape 820.

The fire extinguishing agent may be built in the fire extinguishing sheet 810, and the fire extinguishing tape 820 formed in the fire extinguishing sheet 810 may be attached to the cable 730 to fix the cable 730. The fire extinguishing sheet 810 may be stacked on the fire extinguishing tape 820. An adhesive may be applied to the fire extinguishing tape 820 so as to be attached to the cable 730 and the fixture. The fire extinguishing tape 820 may wind the plurality of cables 730 bundled together to prevent the cables 730 from being separated and may be attached to the fixture to fix the cable 730.

The fire extinguishing sheet 810 may include a sheet body 811 and a sheet capsule 812.

The fire extinguishing tape 820 may be coupled to the sheet body 811. A plurality of sheet capsules 812 may be built in the sheet body 811. The sheet capsule 812 may be a spherical capsule, and may store the fire extinguishing agent inside the capsule.

The sheet body 811 may be molded by mixing epoxy and an additive. As the additive, a hardener for hardening epoxy to induce uniform arrangement of the sheet capsule 812 may be used.

A mixed liquid may be produced by mixing epoxy, the additive, and the sheet capsule 812, and then the mixed liquid may be put into a molding frame and may be left. After a certain amount of time, epoxy may be hardened and the sheet capsule 812 may be uniformly distributed in the epoxy.

A content rate of the sheet capsule 812 may be about 30% to 50%. That is, a volume of the sheet capsule 812 included in the sheet body 811 with respect to a total volume of the sheet body 811 may be 30% to 50%. A capacity of the sheet capsule 812 with respect to a capacity of epoxy and the additive may be 30% to 50%.

The thickness t1 of the fire extinguishing sheet 810 may be designed to be greater by five times to 15 times than the thickness t2 of the fire extinguishing tape 820. That is, if the thickness t2 of the fire extinguishing tape 820 is 1 mm, the thickness t1 of the fire extinguishing sheet 810 may be 5 mm to 15 mm.

The width d of the cable fire extinguishing unit 800 may be 5 mm to 30 mm. If the width d of the cable fire extinguishing unit 500 is less than 5 mm, it is difficult for the sheet capsule 812 to enter the cable fire extinguishing unit 500, and if the width d of the cable fire extinguishing unit 800 is greater than 30 mm, the cable 730 may be lifted.

The cable fire extinguishing unit 800 may surround the plurality of cables 730. An installation interval of the cable fire extinguishing unit 800 may be 100 mm to 200 mm.

The bus bar 720 may be provided on the insulating plate 710 built in the battery module 600 and arranged above the battery cell 610, and may be connected to a terminal provided in each battery cell 610. The cable 730 may be electrically connected to each bus bar 720 and transmit an electrical signal. The cable fire extinguishing unit 800 may surround the plurality of cables 730 such that the plurality of cables 730 connected to each bus bar 720 may be arranged in a bundle. A part of the cable fire extinguishing unit 800 may surround the cable 730 and the other part may be attached to the insulating plate 710 to confine the cable 730.

A description will be made herein of a fire extinguishing operation of a fire extinguishing device 2 for a battery module according to embodiments of the present disclosure structured as described herein.

The control unit 700 and each battery cell 610 may be electrically connected to each other by the cable 730 to transmit and receive signals. Each cable 730 may be separately connected to each battery cell 610, and the cable fire extinguishing unit 800 may surround and fix the plurality of cables 730 in a bundle.

The cable fire extinguishing unit 800 may include an adhesive so as to be attached to the cable 730 and the fixture, and the cable fire extinguishing unit 800 may store a capsule including the fire extinguishing agent. If the cable 730 may be heated due to occurrence of a short-circuit or the cable 730 is heated due to a fire of the battery module 600, the cable fire extinguishing unit 800 melts to block a fire of the cable 730.

In the fire extinguishing device for the energy storage system according to embodiments of the present disclosure and the fire extinguishing device for the battery module according to embodiments of the present disclosure, the cables 450 and 730 may be respectively connected to the battery cells 110 and 610 to transmit and receive electrical signals, and the cable fire extinguishing units 500 and 800 surrounding the respectively the cables 450 and 730 may include fire extinguishing agents to extinguish fires in the cables 450 and 730.

In the fire extinguishing device for the energy storage system according to embodiments of the present disclosure and the fire extinguishing device for the battery module according to embodiments of the present disclosure, the fire extinguishing tapes 520 and 820 are coupled to the fire extinguishing sheets 510 and 810 including the fire extinguishing agents, thereby fixing the cables 450 and 730 by means of an adhesive force of the fire extinguishing tapes 520 and 820.

In the fire extinguishing device for the energy storage system according to embodiments of the present disclosure and the fire extinguishing device for the battery module according to embodiments of the present disclosure, the sheet capsules 512 and 812 are mixed with epoxy and a hardener and then hardened, such that the sheet capsules 512 and 812 are uniformly distributed over the sheet bodies 511 and 811, thereby stably achieving fire extinguishment.

In the fire extinguishing device for the energy storage system and the fire extinguishing device for the battery module according to embodiments of the present disclosure, the cable may be connected to each battery cell to transmit and receive electrical signals, and the cable fire extinguishing unit surrounding the plurality of battery cells may include the fire extinguishing agent to extinguish a fire of the cable.

In the fire extinguishing device for the energy storage system and the fire extinguishing device for the battery module according to embodiments of the present disclosure, the fire extinguishing tape is coupled to the fire extinguishing sheet including the fire extinguishing agent, such that the cable may be fixed by the adhesive force of the fire extinguishing tape.

In the fire extinguishing device for the energy storage system and the fire extinguishing device for the battery module according to embodiments of the present disclosure, the sheet capsule may be mixed with epoxy and the hardener and then hardened, such that the sheet capsule may be uniformly distributed over the sheet body, thereby allowing a fire to be distinguished stably.

According to another aspect of the present disclosure, a vehicle including the fire extinguishing device for the battery module having an improved structure may be provided.

However, the effects obtainable through the present disclosure are not limited to the above effects, and other technical effects that are not mentioned will be clearly understood by those skilled in the art from the following description of the present disclosure.

While the present disclosure has been described with reference to embodiments shown in the drawings, these embodiments are merely illustrative and it should be understood that various modifications and equivalent other embodiments can be derived by those skilled in the art on the basis of the embodiments.

What is claimed is:

1. A fire extinguishing device for an energy storage device, the fire extinguishing device comprising:
a battery module comprising a plurality of battery cells;
a battery rack supporting the battery module;
a module fire extinguishing unit configured to sense a fire of the battery module and spray a fire extinguishing agent on the battery module;
a control unit connected to the battery module through a cable and configured to sense a state of the battery module; and
a cable fire extinguishing unit configured to fix the cable and comprising the fire extinguishing agent.

2. The fire extinguishing device as claimed in claim 1, wherein the module fire extinguishing unit comprises:
a module sensing unit configured to sense at least one of a temperature change and a size change of the battery module; and
a module spraying unit configured to spray a fire extinguishing agent on the battery module according to a sensing signal of the module sensing unit.

3. The fire extinguishing device as claimed in claim 2, wherein the module sensing unit comprises at least any one of:
a temperature sensor configured to sense a temperature of the battery module; and
a size sensor configured to sense a size of the battery module.

4. The fire extinguishing device as claimed in claim 3, wherein the temperature sensor is further configured to measure a temperature of each battery cell in the battery module.

5. The fire extinguishing device as claimed in claim 3, wherein the size sensor is mounted on the battery rack and is further configured to photograph the size of the battery module.

6. The fire extinguishing device as claimed in claim 3, further comprising
a housing comprising the battery rack,
wherein the size sensor is mounted on the housing and is further configured to photograph a size of the battery rack.

7. The fire extinguishing device as claimed in claim 2, wherein the module spraying unit comprises:
a fire extinguishing tank configured to store the fire extinguishing agent;
a fire extinguishing pipe connected to the fire extinguishing tank and configured to guide the fire extinguishing agent; and
a fire extinguishing nozzle formed on the fire extinguishing pipe and configured to spray the fire extinguishing agent on the battery module.

8. The fire extinguishing device as claimed in claim 1, wherein the cable fire extinguishing unit comprises:
a fire extinguishing sheet comprising the fire extinguishing agent; and
a fire extinguishing tape formed on the fire extinguishing sheet and attached to the cable to fix the cable.

9. The fire extinguishing device as claimed in claim 8, wherein the fire extinguishing sheet comprises:
a sheet body to which the fire extinguishing tape is coupled; and
a sheet capsule provided in plural in the sheet body and comprising the fire extinguishing agent.

10. The fire extinguishing device as claimed in claim 9, wherein the sheet body is mixed with epoxy and an additive and molded.

11. The fire extinguishing device as claimed in claim 10, wherein the additive is a hardener hardening the epoxy such that the sheet capsule is uniformly distributed.

12. The fire extinguishing device as claimed in claim 9, wherein a content rate of the sheet capsule is 30% to 50%.

13. The fire extinguishing device as claimed in claim 8, wherein a thickness of the fire extinguishing sheet is greater than a thickness of the fire extinguishing tape by five times to fifteen times.

14. The fire extinguishing device as claimed in claim 8, wherein a width of the cable fire extinguishing unit is 5 mm to 30 mm.

15. The fire extinguishing device as claimed in claim 8, wherein the cable fire extinguishing unit surrounds the cable provided in plural, and an installation interval of the cable fire extinguishing unit is 100 mm to 200 mm.

16. A fire extinguishing device for a battery module, the fire extinguishing device comprising:
a battery module comprising a plurality of battery cells;
a control unit connected to the battery module through a cable and configured to sense a state of the battery module; and
a cable fire extinguishing unit configured to fix the cable and comprising the fire extinguishing agent.

17. The fire extinguishing device as claimed in claim 16, wherein the cable fire extinguishing unit comprises:
a fire extinguishing sheet comprising the fire extinguishing agent; and
a fire extinguishing tape formed on the fire extinguishing sheet and attached to the cable to fix the cable.

18. The fire extinguishing device as claimed in claim 17, wherein the fire extinguishing sheet comprises:
a sheet body to which the fire extinguishing tape is coupled; and
a sheet capsule provided in plural in the sheet body and comprising the fire extinguishing agent.

19. The fire extinguishing device as claimed in claim 18, wherein the sheet body is mixed with epoxy and an additive and molded.

20. The fire extinguishing device as claimed in claim 18, wherein a content rate of the sheet capsule is 30% to 50%.
